(19) United States
(12) Patent Application Publication
(10) Pub. No.: US 2026/0299849 A1
(43) Pub. Date: Oct. 1, 2026

(54) IMAGE FORMING APPARATUS, CONTROL METHOD, AND NON-TRANSITORY COMPUTER-READABLE RECORDING MEDIUM

(71) Applicant: Konica Minolta, Inc., Tokyo (JP)

(72) Inventor: Tetsu KAWASAKI, Tokyo (JP)

(21) Appl. No.: 19/576,580

(22) Filed: Mar. 24, 2026

(30) Foreign Application Priority Data
Mar. 25, 2025 (JP) 2025-049908

(51) Int. Cl. G06F 3/12; G03G 15/00

(52) U.S. Cl. CPC G06F 3/1241; G03G 15/5075; G03G 15/655; G06F 3/1211; G06F 3/1262; G06F 3/1264

(57) ABSTRACT

Provided is an image forming apparatus that includes a hardware processor. The hardware processor acquires a setting content for a post-processing apparatus, and outputs, in a case where a predetermined event has occurred between when printing is started and when the printing is completed, a post-processing instruction that causes the post-processing apparatus to execute a post-processing job corresponding to the setting content.

### CROSS REFERENCE TO RELATED APPLICATIONS

The present invention claims priority under 35 U.S.C. §119 to Japanese Patent Application No. 2025-49908, filed on Mar. 25, 2025, is incorporated herein by reference in its entirety.

### BACKGROUND

### Technical Field

The present invention relates to an image forming apparatus, a control method, and a non-transitory computer-readable recording medium storing a program.

### Description of Related Art

As a printing system operated in a printing factory or the like, there is a printing system that causes a plurality of apparatuses to cooperate with each other by a management information system (MIS), a workflow application, step management software, network communication, and the like. There is a technique that automatically manages such a printing system. In this automatic management, when a plurality of apparatuses cooperates with each other to execute one print job, it is managed such that the print job can be executed without performing any predetermined setting at each apparatus. With this technique, it is possible to reduce the workload of the user and to prevent an erroneous operation due to a setting error.

In relation to the above-described technique, a technique has been disclosed in which a job is divided according to a maximum stacking amount of a post-processing machine before printing starts, and an instruction is given to a post-processing step (for example, Japanese Patent Publication Laid-Open No. 2006-228017). A technique has been disclosed in which the same setting post-processing jobs are integrated and grouped in order to reduce the workload of the worker (for example, Japanese Patent Publication Laid-Open No. 2012-123568).

### SUMMARY

In any of the techniques disclosed in the above-described two patent literatures, there is a problem in that post-processing cannot be executed until printing is completed since a print job cannot be divided at a timing or with the number of output sheets desired by the worker after starting the print job.

The above problem will be described using a specific print job. For example, in a print job in which 1000 copies of 10 pages are printed and saddle stitch is executed by a post-processing apparatus, the post-processing apparatus is instructed to execute bookbinding of 10 pages 1000 times. For this reason, the post-processing apparatus cannot start post-processing until the printing of 1000 copies is completed.

As described above, there is a challenge in the related art that the processing efficiency decreases since the post-processing is started after the printing is completed.

An object of the present invention is to provide an image forming apparatus, a control method, and a non-transitory computer-readable recording medium storing a program, each of which involves improved processing efficiency.

In order to realize at least one of the above-described objects, an image forming apparatus reflecting one aspect of the present invention includes a hardware processor. The hardware processor acquires a setting content for a post-processing apparatus, and outputs, in a case where a predetermined event has occurred between when printing is started and when the printing is completed, a post-processing instruction that causes the post-processing apparatus to execute a post-processing job corresponding to the setting content.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating an example of the overall configuration of a printing system according to the present embodiment;

FIG. 2A is a block diagram illustrating an example of the configuration of a control system of an image forming apparatus;

FIG. 2B is a block diagram illustrating the configuration of a control section;

FIG. 3 is a block diagram illustrating an example of the configuration of a control system of a post-processing apparatus;

FIG. 4 is a flowchart illustrating a flow of processing of the image forming apparatus; and

FIG. 5 is a flowchart illustrating the flow of processing of the image forming apparatus.

### DETAILED DESCRIPTION OF EMBODIMENTS

Hereinafter, one or more embodiments of the present invention will be described with reference to the drawings. However, the scope of the invention is not limited to the disclosed embodiments.

### Printing System

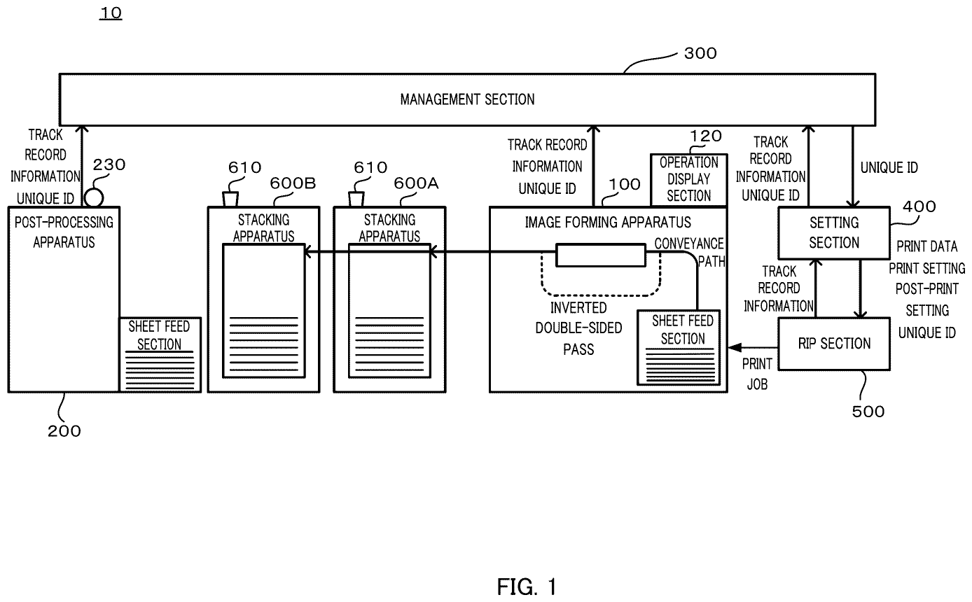

A printing system according to the present embodiment will be described in detail with reference to the accompanying drawings. FIG. 1 illustrates the overall configuration of a printing system 10 according to the present embodiment. The printing system 10 includes an image forming apparatus 100, a post-processing apparatus 200, a management section 300, a setting section 400, a raster image processor (RIP) section 500, and stacking apparatuses 600A and 600B. In the following description, the stacking apparatuses 600A and 600B will be expressed as the stacking apparatus 600 when the stacking apparatuses 600A and 600B are not particularly distinguished from each other.

The management section 300 executes management processing such as the management, track record, and cost management of the printing system 10 in its entirety. In this management processing, a management information system (MIS)/manufacturing execution system (MES)/printing step application is used. In addition, the management section 300 outputs a print request, which has been received from an end user, to the setting section 400. A unique ID is assigned to the print request. The unique ID is information for uniquely identifying an individual print request. The management section 300 is an example of a host apparatus.

The setting section 400 determines the imposition of a print image, the print setting of the image forming apparatus 100, and the setting for the post-processing apparatus 200 (hereinafter, referred to as “post-processing setting”) in response to a print request inputted from the management section 300. The setting section 400 outputs, together with a unique ID, print data indicating an image to be printed, print setting, and post-processing setting to the RIP section 500. In addition, the setting section 400 outputs a unique ID and track record information to the management section 300. The track record information is information indicating a processing result or the like of a print request specified by a unique ID.

The RIP section 500 rasterizes print data inputted from the setting section 400 based on the print setting to generate raster image data. The RIP section 500 generates print job data indicating a print job and outputs the print job data to the image forming apparatus 100. The print job data includes raster image data, a unique ID, and post-processing setting. In addition, the RIP section 500 outputs a unique ID and track record information to the setting section 400.

The image forming apparatus 100 receives a sheet from a sheet feed section via a conveyance path according to the print job data inputted from the RIP section 500, prints an image on the sheet, and ejects the sheet to the stacking apparatus 600. In the following description, a sheet on which an image has been printed will also be referred to as a “printed material”. The image forming apparatus 100 outputs a unique ID and track record information to the management section 300. In addition, the image forming apparatus 100 acquires a setting content for the post-processing apparatus from post-processing setting included in print job data.

In a case where a predetermined event occurs between when printing of a plurality of pages is started and when from the printing is completed, the image forming apparatus 100 outputs a post-processing instruction that causes the post-processing apparatus 200 to execute a post-processing job corresponding to the setting content. Specifically, the image forming apparatus 100 outputs, as the post-processing instruction, a sheet on which information on a post-processing job has been printed (hereinafter, the above sheet will also be referred to as an “instruction sheet”). The information on a post-processing job includes, for example, information indicating that bookbinding of 10 pages is executed 1000 times. That is, the information on a post-processing job is information specifically indicating what kind of post-processing is to be performed. The information on a post-processing job is expressed by, for example, a barcode.

The stacking apparatus 600 stacks a printed material ejected by the image forming apparatus 100. In the present embodiment, the user delivers a printed material stacked in the stacking apparatus 600 to the post-processing apparatus 200. For this reason, the stacking apparatus 600 is provided with a removal button 610 for a user to remove a printed material from the stacking apparatus 600. The image forming apparatus 100 is notified that the removal button 610 has been pressed.

In the present embodiment, the post-processing apparatus 200 is an offline post-processing apparatus. The post-processing apparatus 200 receives a sheet conveyed from the sheet feed section and performs post-processing thereon according to post-processing setting. The post-processing apparatus 200 includes a code reading section 230. The post-processing apparatus 200 reads a barcode printed on an instruction sheet by the code reading section 230 and acquires a setting content for the post-processing apparatus 200, which is indicated by the barcode. Alternatively, the post-processing apparatus 200 may acquire, as the setting content, a content inputted by the user through an input apparatus such as a panel (not illustrated). The post-processing apparatus 200 outputs a unique ID and track record information to the management section 300. Note that, the image forming apparatus 100 and the post-processing apparatus 200 may be configured to be communicable with each other, and the image forming apparatus 100 may output information on a post-processing job as the post-processing instruction to the post-processing apparatus 200 by using a communication line.

### Configuration of Image Forming Apparatus

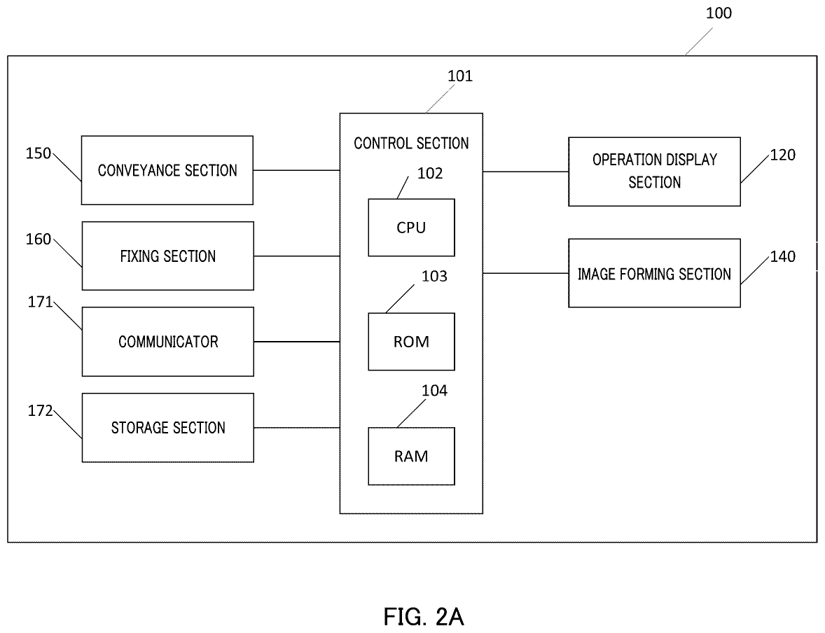

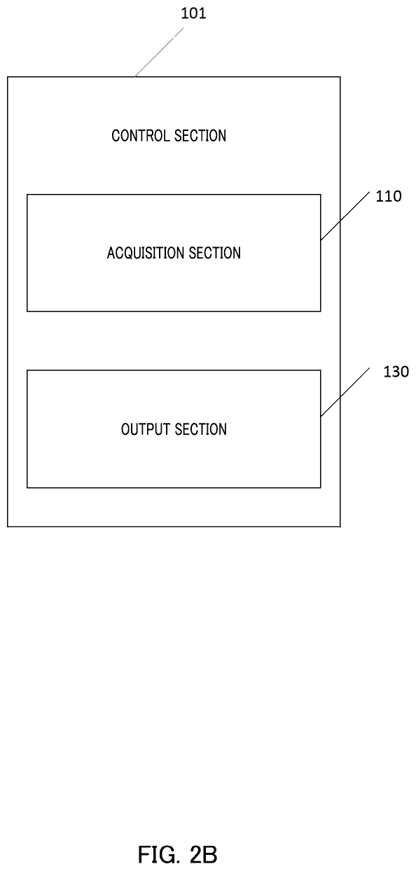

Next, the configuration of a control system of the image forming apparatus 100 will be described. FIG. 2A is a diagram illustrating the configuration of the control system of the image forming apparatus 100.

The image forming apparatus 100 includes a control section 101, a conveyance section 150, a fixing section 160, a communicator 171, a storage section 172, an operation display section 120, and an image forming section 140.

The control section 101 includes a central processing unit (CPU) 102, a read only memory (ROM) 103, a random access memory (RAM) 104, and the like. The CPU 102 reads a program corresponding to the processing content from the ROM 103, develops the program in the RAM 104, and controls the operation of each block of the image forming apparatus 100 in cooperation with the developed program. At this time, various types of data and raster image data stored in the storage section 172 are referred to. The storage section 172 is constituted by, for example, a non-volatile semiconductor memory (so-called flash memory) or a hard disk drive. In addition, a unique ID and post-processing setting included in a print job are stored in the RAM 104.

The control section 101 transmits and receives various types of data to and from the management section 300, the RIP section 500, and the like connected to a communication network such as a local area network (LAN), a wide area network (WAN) via the communicator 171. The communicator 171 is constituted by a communication control card such as a LAN card.

The operation display section 120 is constituted by, for example, a liquid crystal display (LCD) with a touch screen, and functions as a display section and an operation section. The display section displays various operation screens, various states of images, operation statuses of the respective functions, and the like according to a display control signal inputted from the control section 101. The operation section includes various operation keys such as a numeric keypad and a start key, receives various input operations by the user, and outputs an operation signal to the control section 101.

The image forming section 140 emits laser light based on inputted raster image data and applies the emitted laser light to the photosensitive drum, thereby forming an electrostatic latent image on the photosensitive drum (exposure step).

The image forming section 140 has a configuration for executing, in addition to the above-described exposure step, each of a charging step performed before the exposure step, a developing step performed after the exposure step, a transfer step after the developing step, and a cleaning step after the transfer step.

In the charging step, the image forming section 140 uniformly charges the surface of the photosensitive drum by corona discharge from a charging apparatus. In the developing step, the image forming section 140 forms a toner image on the photosensitive drum by causing toner included in a developer in a developing apparatus to adhere to the electrostatic latent image on the photosensitive drum.

In the transfer step, the image forming section 140 transfers the toner image on the photosensitive drum onto a sheet conveyed by the conveyance section 150. In the cleaning step, the image forming section 140 removes the toner remaining on the photosensitive drum after the transfer step.

The fixing section 160 applies heat and pressure (heating and fixing) to the toner image on the sheet introduced into a fixing nip section, thereby fixing the toner image on the sheet (fixing step). As a result, a fixed toner image is formed on the sheet. As described above, the aforementioned steps are performed at the image forming apparatus 100, and thus, a toner image based on the raster image data is formed (transferred) and fixed on the sheet. The printed material on which a toner image has been fixed is ejected to the stacking apparatus 600 at the subsequent stage (on the downstream side).

FIG. 2B is a block diagram illustrating details of the control section 101. As illustrated in FIG. 2B, the control section 101 includes an acquisition section 110 and an output section 130. The acquisition section 110 acquires a setting content for the post-processing apparatus 200. In a case where a predetermined event occurs between when printing is started and when the printing is completed, the output section 130 outputs a post-processing instruction that causes the post-processing apparatus 200 to execute a post-processing job corresponding to the setting content. The processing content at the acquisition section 110 and the output section 130 will be described with reference to the below-described flowcharts and the like.

### Configuration of Post-Processing Apparatus

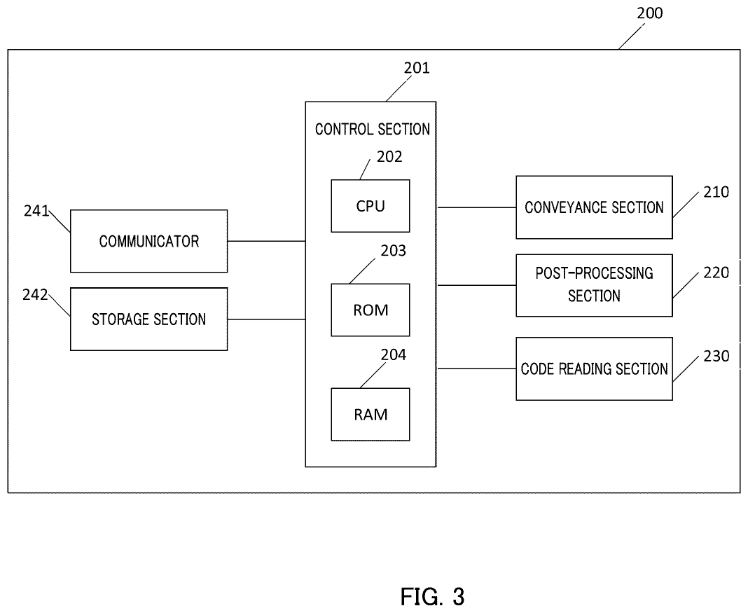

Next, the configuration of a control system of the post-processing apparatus 200 will be described. FIG. 3 is a diagram illustrating the configuration of the control system of the post-processing apparatus 200.

The post-processing apparatus 200 includes a control section 201, a conveyance section 210, a post-processing section 220, a code reading section 230, a communicator 241, and a storage section 242.

The control section 201 includes a CPU 202, a ROM 203, a RAM 204, and the like. The CPU 202 reads a program corresponding to the processing content from the ROM 203, develops the program in the RAM 204, and controls the operation of each block of the post-processing apparatus 200 in cooperation with the developed program. At this time, various types of data stored in the storage section 242 are referred to. The storage section 242 is constituted by, for example, a non-volatile semiconductor memory (so-called flash memory) or a hard disk drive.

The conveyance section 210 includes a sheet conveyance route, a conveyance roller, and the like, and has a function of supplying a printed material in the sheet feed section to the post-processing section 220 and a sheet ejection tray (not illustrated) under the control of the control section 201. The post-processing section 220 performs post-processing on a printed material. The post-processing includes stapling, punching processing, sheet-folding, creasing, perforation, cutting, and the like, and a post-processing section suitable for the purpose of the user is provided.

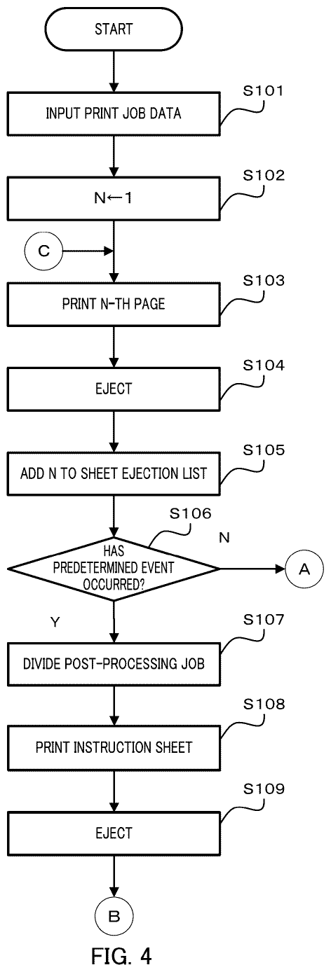

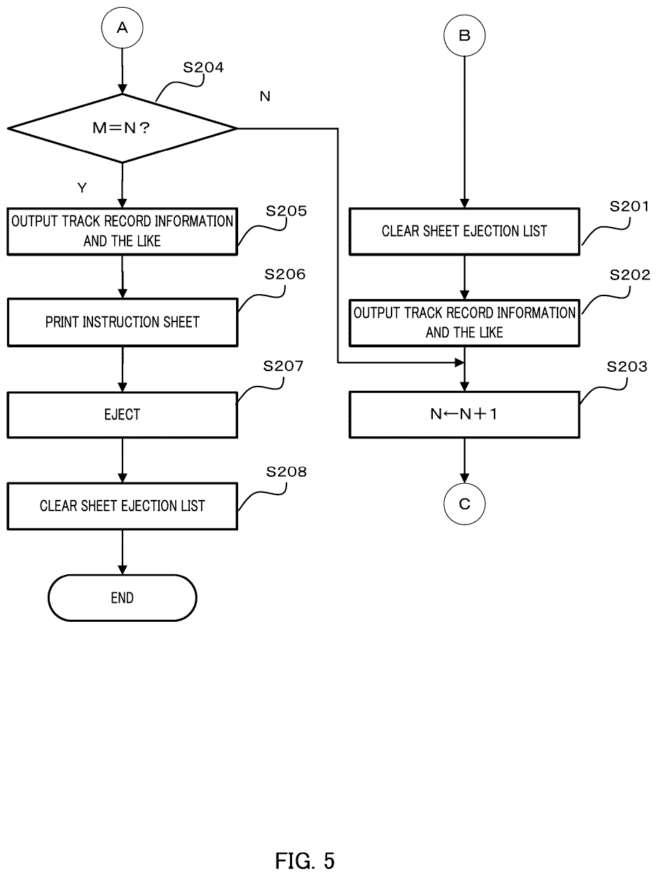

FIGS. 4 and 5 are flowcharts illustrating the flow of processing of the image forming apparatus 100. It is assumed that the image forming apparatus 100 performs printing of M pages in the processing illustrated in the flowcharts.

### Processing of Image Forming Apparatus

In FIG. 4, when print job data is inputted from the RIP section 500 (step S101), the image forming apparatus 100 substitutes 1 for a page counter N (step S102). The page counter is a counter for counting pages. The image forming apparatus 100 prints an N-th page based on raster image data corresponding to the N-th page (step S103) and ejects the printed N-th page (step S104). The image forming apparatus 100 adds N to a sheet ejection list (step S105). The sheet ejection list is a list indicating pages on which post-processing has not been performed by the post-processing apparatus 200. Note that, in a case where there is a plurality of sheet ejection destinations, a sheet ejection list may be provided for each of the sheet ejection destinations.

The image forming apparatus 100 determines whether a predetermined event has occurred (step S106). Details of the predetermined event will be described later. In a case where a predetermined event has occurred (step S106: YES), the image forming apparatus 100 divides a post-processing job based on the time point at which the predetermined event has occurred (step S107). The image forming apparatus 100 prints an instruction sheet indicating a post-processing instruction that causes the post-processing apparatus 200 to execute the divided post-processing jobs (step S108) and ejects the instruction sheet (step S109).

Then, the image forming apparatus 100 proceeds to step S201 in FIG. 5 and clears the sheet ejection list (step S201). To clear the sheet ejection list means to delete all pages on the sheet ejection list. The image forming apparatus 100 outputs the unique ID and the track record information to the management section 300 (step S202). Then, the image forming apparatus 100 increments the page counter N by one (step S203), and proceeds to step S103 in FIG. 4.

In a case where a predetermined event has not occurred in step S106 (step S106: NO), the image forming apparatus 100 proceeds to step S204 in FIG. 5. The image forming apparatus 100 determines whether the page counter N is equal to M (step S204). That is, the image forming apparatus 100 determines whether all the pages have been printed. In a case where the page counter N is different from M (step S204: NO), the image forming apparatus 100 proceeds to step S203 described above. Note that it may also be configured such that in step S204, an affirmative determination is performed even in a case where the print job has been interrupted for some reason such as an error. In this case, the instruction sheet at the time point of the interruption is printed in the subsequent step S206, and thus, post-processing can be performed on the printed material before the interruption.

In a case where the page counter N is equal to M (step S204: YES), the image forming apparatus 100 outputs the unique ID and the track record information to the management section 300 (step S205). The image forming apparatus 100 prints an instruction sheet indicating a post-processing instruction that causes the post-processing apparatus 200 to execute a post-processing job for the pages listed in the sheet ejection list (step S206), and ejects the instruction sheet (step S207). The image forming apparatus 100 clears the sheet ejection list (step S208) and ends the present processing.

As illustrated in the above-described flowcharts, the image forming apparatus 100 according to the present embodiment outputs, in a case where a predetermined event has occurred between when printing is started and the printing is completed, a post-processing instruction that causes the post-processing apparatus 200 to execute a post-processing job corresponding to a setting content. In this way, since the post-processing can be started without waiting until the printing is completed, processing efficiency can be improved. In addition, the image forming apparatus 100 can output a post-processing instruction according to a sheet ejection list for each of divided post-processing jobs.

Note that the image forming apparatus 100 may output a division position of a post-processing job, which is based on the time point at which the predetermined event has occurred, and the post-processing instruction. In this case, for example, the post-processing content may be instructed to the post-processing apparatus 200 in advance, and the division position may be outputted at a timing with which a predetermined event has occurred. For example, in a case where a predetermined event has occurred at the time point at which the printing of the fifth page ends, the division position here may be expressed in terms of the page number, such as the fifth page or the sixth page. Even in this case, the post-processing can be started without waiting until the printing is completed, and thus, processing efficiency can be improved.

Next, the predetermined event will be described.

As the predetermined event, the following four events (1) to (4) will be exemplified:
(1) detection of a user operation;
(2) printing on a sheet set in advance by the user;
(3) printing of a page set in advance by the user; and
(4) an occurrence of an error.

Even in any one of the events (1) and (4) described above, the post-processing can be started without waiting until the printing is completed, and thus, processing efficiency can be improved. Note that examples of the user operation in (1) include removal of a printed sheet stacked in the stacking apparatus 600 by the user, and an input of a division instruction into the image forming apparatus 100 by the user. Examples of the error in (4) includes a paper jam.

The post-processing job may be a job that is divided into predetermined post-processing units. Specifically, processing of binding each time 10 sheets are printed may be divided as one post-processing unit. In this case, for example, in a case where a predetermined event has occurred when the number of printed sheets is less than 10, the instruction sheet may not be printed at that time point and the instruction sheet may be printed after 10 sheets are printed. In addition, the post-processing instruction may include information indicating the execution order of a plurality of divided post-processing jobs. In addition, the image forming apparatus 100 may allow reprinting in units of divided post-processing jobs. Thus, even in a case where there is a malfunction in printing for some reason, reprinting can be easily performed.

To the track record information in step S202 described above, a configuration may be applied in which the track record information is notified at a timing with which the post-processing job is divided, and the track record information is managed as divided post-processing jobs in the printing system 10 in its entirety. In addition, a configuration may be applied in which only the division position is notified to the management section 300 and the notification of the track record information of the post-processing job, or the like, to the management section 300 is performed for the post-processing job as a whole.

The image forming apparatus 100 may eject sheets corresponding to divided post-processing jobs to different sheet ejection destinations for each of the divided post-processing jobs or may eject sheets corresponding to divided post-processing jobs to different sheet ejection positions for each of the divided post-processing jobs. In addition, the image forming apparatus 100 may eject a partition sheet correspondingly to a division position. Thus, the user can recognize a division position.

Note that, in the image forming apparatus 100, in a case where a plurality of print jobs that performs identical post-processing is consecutively performed, the output section 130 may not output the post-processing instruction when one print job of the plurality of print jobs is completed, and may output the post-processing instruction when the next print job of the plurality of print jobs is executed.

As described above, according to the present embodiment, the post-processing can be started without waiting until the printing is completed, and thus, processing efficiency can be improved. This improvement in processing efficiency also makes it possible to improve the productivity of the printing system 10.

In addition, any of the above-described embodiment is merely an example for implementing the present invention, and the technical scope of the present invention should not be interpreted in a limited manner thereby. That is, the present invention can be implemented in various forms without departing from the spirit or main features thereof.

Further, although a color image forming apparatus utilizing the electrophotographic process technique has been described as an example in the foregoing embodiment, the present invention is also applicable to a color image forming apparatus utilizing the inkjet technique.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming apparatus, comprising a hardware processor, wherein
the hardware processor
acquires a setting content for a post-processing apparatus, and
outputs, in a case where a predetermined event has occurred between when printing is started and when the printing is completed, a post-processing instruction that causes the post-processing apparatus to execute a post-processing job corresponding to the setting content.

2. The image forming apparatus according to claim 1, wherein
the hardware processor outputs the post-processing instruction for each of a plurality of the post-processing jobs obtained by dividing the post-processing job.

3. The image forming apparatus according to claim 1, wherein
the hardware processor outputs a division position of the post-processing job and the post-processing instruction, the division position being based on a time point at which the predetermined event has occurred.

4. The image forming apparatus according to claim 1, wherein
the hardware processor outputs, as the post-processing instruction, a sheet on which information on the post-processing job has been printed.

5. The image forming apparatus according to claim 1, further comprising a communicator that
communicates with the post-processing apparatus, wherein
the hardware processor outputs information on the post-processing job as the post-processing instruction to the post-processing apparatus via the communicator.

6. The image forming apparatus according to claim 1, wherein
the post-processing instruction indicates an execution order of a plurality of the post-processing jobs obtained by dividing the post-processing job.

7. The image forming apparatus according to claim 1, wherein
the predetermined event is a user operation, printing on a sheet set in advance, printing of a page set in advance, or an occurrence of an error.

8. The image forming apparatus according to claim 1, wherein
the post-processing job is divided into predetermined post-processing units.

9. The image forming apparatus according to claim 1, wherein
the image forming apparatus allows reprinting in units of a plurality of the post-processing jobs obtained by dividing the post-processing job.

10. The image forming apparatus according to claim 1, wherein
the image forming apparatus ejects sheets corresponding to a plurality of the post-processing jobs to different sheet ejection destinations for each of the plurality of post-processing jobs, the plurality of post-processing jobs being obtained by dividing the post-processing job.

11. The image forming apparatus according to claim 1, wherein
the image forming apparatus ejects sheets corresponding to a plurality of the post-processing jobs to different sheet ejection positions for each of the plurality of post-processing jobs, the plurality of post-processing jobs being obtained by dividing the post-processing job.

12. The image forming apparatus according to claim 1, wherein
the image forming apparatus ejects a partition sheet correspondingly to a division position of the post-processing job.

13. The image forming apparatus according to claim 1, wherein
in a case where the printing is stopped or interrupted, the hardware processor outputs the post-processing instruction that causes the post-processing apparatus to execute the post-processing job that is performed on a sheet on which the printing has been performed at a time point at which the printing is interrupted.

14. The image forming apparatus according to claim 1, wherein
a notification to a host apparatus is performed at a timing with which the post-processing job is divided, or the notification to the host apparatus is performed for the post-processing job as a whole, the host apparatus performing management related to the printing and post-processing.

15. The image forming apparatus according to claim 1, wherein
in a case where a plurality of print jobs that performs identical post-processing is continuously performed, the hardware processor does not output the post-processing instruction when one print job of the plurality of print jobs has been completed, and the hardware processor outputs the post-processing instruction when a next print job of the plurality of print jobs is executed.

16. A control method of an image forming apparatus, comprising:
acquiring a setting content for a post-processing apparatus; and
outputting, in a case where a predetermined event has occurred between when printing is started and when the printing is completed, a post-processing instruction that causes the post-processing apparatus to execute a post-processing job corresponding to the setting content.

17. A non-transitory computer-readable recording medium storing a program that causes a
computer to execute:
acquiring a setting content for a post-processing apparatus; and
outputting, in a case where a predetermined event has occurred between when printing is started and when the printing is completed, a post-processing instruction that causes the post-processing apparatus to execute a post-processing job corresponding to the setting content.
